(19) United States
(12) Patent Application Publication
(10) Pub. No.: US 2011/0205437 A1
(43) Pub. Date: Aug. 25, 2011

(54) METHOD OF ZOOMING IN ON AN IMAGE AND A METHOD OF USING A GUI

(75) Inventor: JHIH-SYUN HOU, Taipei (TW)

(73) Assignee: ABILITY ENTERPRISE CO., LTD., Taipei (TW)

(21) Appl. No.: 12/792,695

(22) Filed: Jun. 2, 2010

(30) Foreign Application Priority Data
Feb. 24, 2010 (TW) 099105328

(51) Int. Cl. H04N 9/74; G06F 3/048

(52) U.S. Cl. 348/581; 715/800; 348/E09.055

(57) ABSTRACT

The present invention is directed to a method of zooming in on an image. An object is firstly detected, followed by capturing an image and recording the location and size of the object. The captured image is displayed on a screen with the detected object marked. A partial image of the captured image is determined according to the location of the object. The determined partial image then fills up the entire screen, thereby zooming in on the object.

### CROSS-REFERENCE TO RELATED APPLICATIONS

The entire contents of Taiwan Patent Application No. 099105328, filed on Feb. 24, 2010, from which this application claims priority, are incorporated herein by reference.

### BACKGROUND OF THE INVENTION

1. Field of the Invention

The present invention generally relates to an imaging device, and more particularly to a method of zooming in on an image of a digital camera.

2. Description of Related Art

Most digital cameras nowadays are equipped with liquid crystal displays (LCDs), through which users can view captured pictures on the LCD immediately after shooting. In case of blur or not as expected, users can shoot another picture again. Owing to small LCD in most digital cameras, it is difficult for users to view details, for example, of a human face in the picture. Accordingly, users often use zoom-in facility provided by the camera to view the details in the picture.

FIG. 1 shows a zoom-in example while viewing an image in a conventional digital camera. When investigating a human face on the right-hand side of block 11, a user utilizes a shift control button to move the human face to the center of the screen (block 12). Subsequently, the user utilizes a zoom-in button to magnify the human face to be investigated (block 13). Alternatively, the user may zoom in the human face, followed by shifting it to the center of screen. However, the shifting and zooming in either case take a great time. Moreover, as the number or kinds of the objects (e.g., many human faces) on a picture is great, more time is required to investigate all the objects. Further, some of the objects may be missed, or some of the objects may be investigated more than once.

Therefore, a need has arisen to propose a novel method of zooming in on an image and a GUI to facilitate zooming in on an object of the image for users in a convenient and fast manner.

### SUMMARY OF THE INVENTION

In view of the foregoing, a method of zooming in on an image and a method of using graphic user interface (GUI) of the imaging device are disclosed. The disclosed method is capable of directly zooming in on a detected object while a picture is browsed by a user. The disclosed method is further capable of directly switching among plural detected objects, thereby substantially increasing efficiency and speed while browsing the picture.

According to a method of zooming in on an image as disclosed in one embodiment of the present invention, an object is firstly detected, and an image is captured and the location and size of the object are recorded. The captured image is displayed on a screen with the detected object marked. A partial image of the captured image is determined according to the location of the object, wherein the determined partial image includes the object. The determined partial image then fills up the entire screen, thereby zooming in on the object.

According to a method of using a graphical user interface (GUI) of an imaging device as disclosed in another embodiment of the present invention, firstly, a captured image is displayed on a screen of the imaging device and at least one detected object is marked, wherein the location and size of the object are recorded in the imaging device. Subsequently, a select signal is received to select one of the objects, and a zoom-in signal is received. A partial image of the captured image is determined according to the zoom-in signal and the location of the selected object. The determined partial image then fills up the entire screen, thereby zooming in on the object.

### BRIEF DESCRIPTION OF THE DRAWINGS

FIG. 1 shows a zoom-in example while viewing an image in a conventional digital camera;

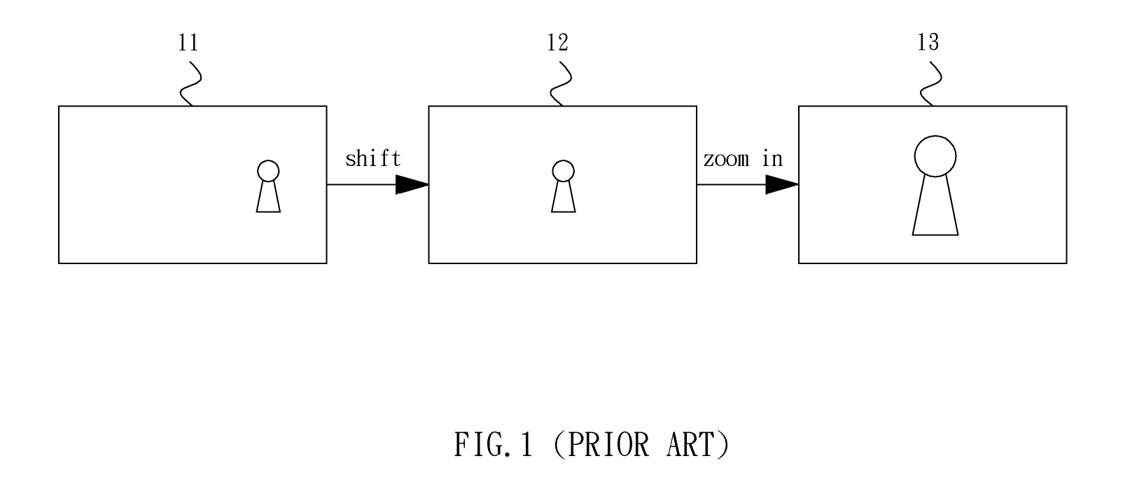

FIG. 2 shows a flow diagram that illustrates a method of zooming in on an image and a method of using a GUI of the imaging device according to one embodiment of the present invention;

FIG. 3 shows an example of zooming in/out an image according to the embodiment of the present invention;

FIG. 4 shows a screen, an object and a scaled area; and

FIG. 5 shows another example of zooming in/out an image according to the embodiment of the present invention.

### DETAILED DESCRIPTION OF THE INVENTION

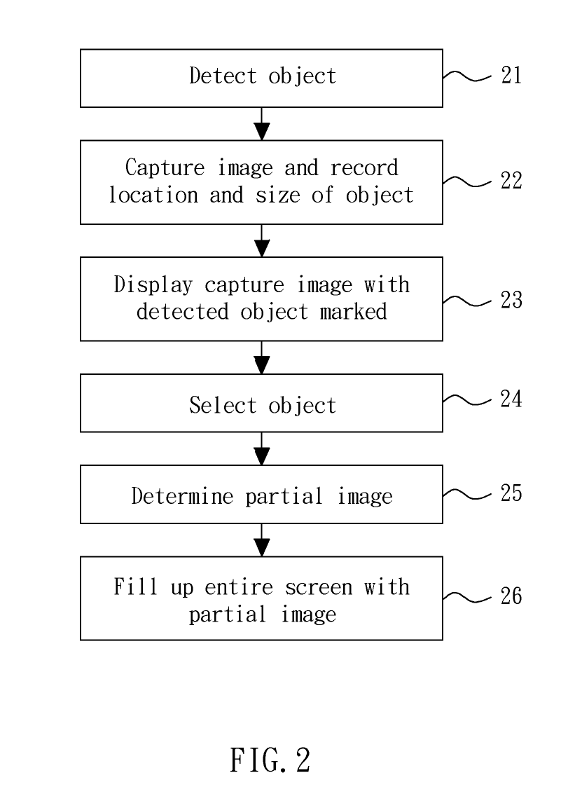

FIG. 2 shows a flow diagram that illustrates a method of zooming in on an image and a method of using a graphical user interface (GUI) of the imaging device according to one embodiment of the present invention. In the embodiment, the imaging device may be, but not limited to, a digital camera.

Firstly, at least one object (for example, a human face or a general (non-face) object) is detected in step 21. With respect to the human face, a general face detection technology may be used. With respect to a general non-face object, the image of an object to be detected may be pre-stored in the digital camera and then a general image detection technology may be utilized to detect the object.

Subsequently, in step 22, a user presses the shutter button of the digital camera to capture an image including the detected object, and then the location and size of the detected object is recorded in the digital camera. In the embodiment, the location and size of the detected object may be stored in, but not limited to, a MakerNote field of a file of exchangeable image file format (Exif). The exchangeable image file format is specified by Japan Electronic Industries development Association (JEIDA).

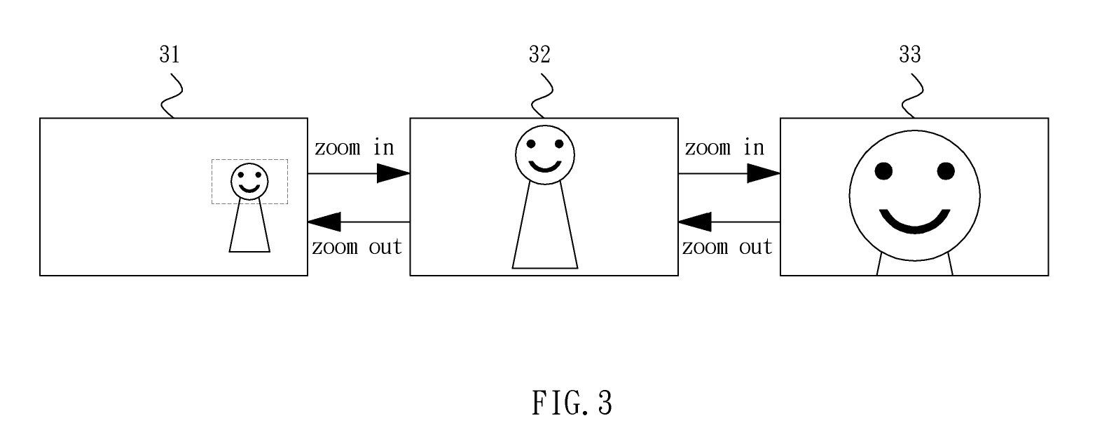

In step 23, the captured image is displayed on the screen (for example, a liquid crystal display (LCD)) of the digital camera, and the detected object is marked, for example, with a dotted frame as shown in block 31 of FIG. 3. However, the detected object may be marked by other ways, such as by highlighting the detected object with luminance greater than other non-detected areas.

In step 24, the user issues a select signal to the digital camera via a select control button (or other input schemes) to select the detected object or select one of the detected objects.

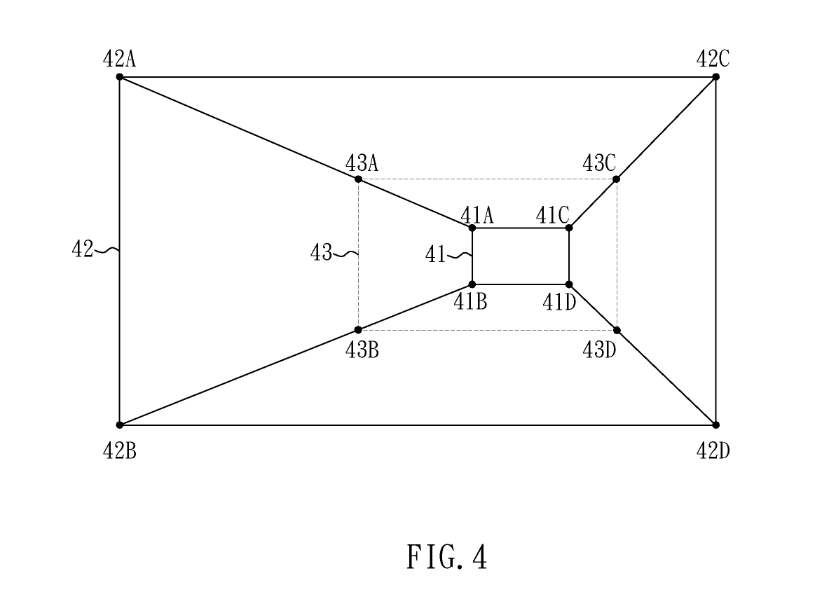

Afterward, in step 25, the user issues a zoom-in signal to the digital camera via a zoom-in control button (or other input schemes) to perform zoom in on the selected object. As shown in FIG. 4, the digital camera determines a partial image 43 including the selected object within the captured image 42 according to the zoom-in signal and the location of the object 41. Specifically, in one embodiment, a corner location (e.g., 41A) of the object 41 is obtained according to the recorded location, and a corresponding corner location 42A of a corresponding screen (for example, the entire captured image 42) is also obtained. A point (e.g., 43A) is selected on a line connected between the corner location 41A of the object and the corner location 42A of the screen. A scaled area 43 passing the selected point 43A is determined to act as the partial image according to the recorded size. Finally, in step 26, the determined partial image 43 fills up the entire image, thereby zooming in on the object that is displayed on the screen, as shown in block 32 of FIG. 3. The steps 25 and 26 may be repeated to further zoom in on the image, as shown in block 33 of FIG. 3.

In another embodiment, in step 25, four corner locations 41A-41D of the object 41 are obtained according to the recorded location and size. Specifically, each corner location of the object 41 corresponds to a corner location of the screen 42, thereby obtaining four location pairs, i.e., (41A,42A), (41B,42B), (41C,42C) and (41D,42D). For each location pair, a point is selected on a line connected between the corner location of the object 41 and the corresponding corner location of the screen 42. Thereafter, a scaled area 43 passing the selected four points is determined to act as the partial image 43. Finally, in step 26, the determined partial image 43 fills up the entire screen, thereby zooming in on the object that is displayed on the screen.

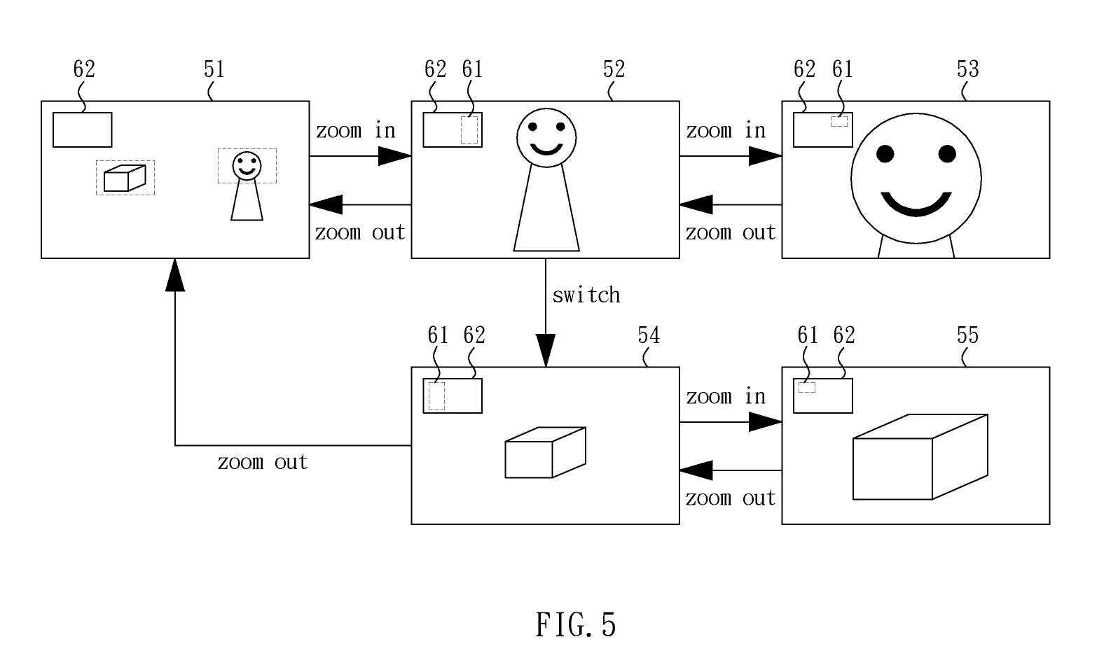

According to the method of zooming in on the image as described above, the user can quickly view and zoom in on the object (for example, a human face), as exemplified in FIG. 5. Firstly, the screen displays an originally captured image (block 51) with detected objects marked, for example, with dotted frame. In the present example, there are two objects detected and marked. Subsequently, when the user select one object (e.g., the object on the right-hand side), the digital camera automatically zooms in on the selected object and places the selected object approximately at the center of the screen, as shown in block 52, according to the steps 25 and 26 described above. Further, the user may further zoom in on the image with more magnification (as shown in block 53), or may zoom out on the image. When the user select another detected object (e.g., the object on the left-hand side), the digital camera automatically switches to the selected object according to the location of the object, and zooms in on the selected object and places it approximately at the center of the screen, as shown in block 54, according to the steps 25 and 26 described above. Further, the user may further zoom in on the image with more magnification (as shown in block 55), or may zoom out on the image.

According to one embodiment, in order to facilitate a general understanding of the currently displayed partial image with respect to the entire capture image for the user, a relative location between the current image and the originally captured image is displayed on the screen of the digital camera. As shown in FIG. 5, after the object is zoomed in (e.g., block 52), the relative location of the current image 61 with respect to the originally captured image 62 is displayed on the top-left corner of the screen. When the object is further zoomed in (e.g., block 52), the relative location of the current image 61 with respect to the originally captured image 62 is updated on the top-left corner of the screen.

Although specific embodiments have been illustrated and described, it will be appreciated by those skilled in the art that various modifications may be made without departing from the scope of the present invention, which is intended to be limited solely by the appended claims.

1. A method of zooming in on an image, comprising:
detecting an object;
capturing an image and recording a location, and size of the object;
displaying the captured image on a screen with the detected object marked;
determining a partial image of the captured image according to the location of the object, the determined partial image including the object; and
filling up the entire screen with the determined par image, thereby zooming in on the object.

2. The method of claim 1, wherein the object is a human face.

3. The method of claim 1, wherein the object is a pre-stored object image.

4. The method of claim 1, wherein, the location and size of the object is stored in a file of exchangeable image file format (Exif).

5. The method of claim 4, wherein the location and size of the object is stored in a MarkerNote filed of the Exif file.

6. The method of claim 1, wherein the step of determining the partial image comprises:
obtaining a corner location of the object according to the recorded location;
corresponding the corner location of the object to a corner location of the screen;
selecting a point on a line connected between the corner location of the object and the corresponding corner location of the screen; and
determining a scaled area passing the selected point to act as the partial image according to the recorded size.

7. The method of claim 1, wherein the step of determining the partial image comprises:
obtaining four corner locations of the object according to the recorded location and size of the object, wherein each of the corner locations of the object corresponds to a corner location of the screen, thereby obtaining four location pairs;
selecting a point on a line connected between each said corner location of the object and the corresponding corner location of the screen for each said location pair; and
determining a scaled area passing the selected four points to act as the partial image.

8. The method of claim 6, further comprising:
displaying a relative location between the scaled area and the originally captured image on the screen.

9. A method of using a graphical user interface (GUI) of an imaging device, comprising:
displaying a captured image on a screen of the imaging device and marking at least one detected object, wherein a location and size of the detected object are recorded in the imaging device;
receiving a select signal to select one of the objects;
receiving a zoom-in signal;
determining a partial image of the captured image according to the zoom-in signal and the location of the selected object; and
filling up the entire screen with the determined partial image, thereby zooming in on the object.

10. The method of claim 9, wherein the object is a human face.

11. The method of claim 9, wherein the object is a pre-stored object image.

12. The method of claim 9, wherein the location and size of the object is stored in a file of exchangeable image file format (Exif).

13. The method of claim 12, wherein the location and size of the object is stored in a MarkerNote field of the Exif file.

14. The method of claim 9, wherein the step of determining the partial image comprises:
obtaining a corner location of the selected object according to the recorded location;
corresponding the corner location of the selected object to a corner location of the screen;
selecting a point on a line connected between the corner location of the object and the corresponding corner location of the screen; and
determining a scaled area passing the selected point to act as the partial image according to the recorded size.

15. The method of claim 9, wherein the step of determining the partial image comprises:
obtaining four corner locations of the selected object according to the recorded location and size of the object, wherein each of the corner locations of the object corresponds to a corner location of the screen, thereby obtaining four location pairs;
selecting a point on a line connected between each said corner location of the object and the corresponding corner location of the screen for each said location pair; and
determining a scaled area passing the selected four points to act as the partial image.

16. The method of claim 14, further comprising:
displaying a relative location between the scaled area and originally captured image on the screen.

17. The method of claim 9, wherein the imaging device is a digital camera.

18. The method of claim 7, further comprising:
displaying a relative location between the scaled area and the originally captured image on the screen.

19. The method of claim 15, further comprising:
displaying a relative location between the scaled area and the originally captured image on the screen.
